(19) United States
(12) Patent Application Publication
(10) Pub. No.: US 2023/0101239 A1
(43) Pub. Date: Mar. 30, 2023

(54) TERMINAL AND RADIO COMMUNICATION METHOD

(71) Applicant: NTT DOCOMO, INC., Tokyo (JP)

(72) Inventors: Shinya Kumagai, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 17/766,966

(22) PCT Filed: Oct. 11, 2019
(86) PCT No.: PCT/JP2019/040175

§ 371 Date: Apr. 6, 2022

(51) Int. Cl. H04W 72/02; H04W 4/50; H04W 56/00; H04B 7/06; H04W 24/10; H04W 72/23

(52) U.S. Cl. CPC H04W 72/02; H04W 4/50; H04W 56/001; H04B 7/0626; H04W 24/10; H04W 72/23

(57) ABSTRACT

A terminal according to one aspect of the present disclosure includes: a receiving section configured to receive information on association between services and resources; and a transmitting section configured to perform transmission processing by using a resource that is included in the information on association and corresponds to a service to be used. According to one aspect of the present disclosure, when there are TRPs to which different services are applied, communication can be appropriately controlled.

### TECHNICAL FIELD

The present disclosure relates to a terminal and a radio communication method in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G+ (plus),” “New Radio (NR),” “3GPP Rel. 15 (or later versions),” and so on) are also under study.

In existing LTE systems (for example, 3GPP Rel. 8 to Rel. 14), a user terminal (User Equipment (UE)) transmits uplink control information (UCI) by using at least one of a UL data channel (for example, Physical Uplink Shared Channel (PUSCH)) and a UL control channel (for example, Physical Uplink Control Channel (PUCCH)).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, NR), a system is under consideration that allows operation of 5G systems not only for telecommunications carriers (operators) licensed for a certain frequency region but also for business operators other than the licensed telecommunications carriers by restricting conditions. In this case, it is assumed that a plurality of networks with different business operators are operated in the certain frequency region. Different services may be applied to the plurality of networks.

However, when existing functions are used, it is difficult to appropriately control communication when there are TRPs that support different services. For example, when there are TRPs of different services, it is difficult to connect only a specific UE to a Transmission/Reception Point (TRP) that supports a specific service.

An object of the present disclosure is to provide a terminal and a radio communication method, whereby communication is appropriately controlled when there are TRPs that support different services.

### Solution to Problem

A terminal according to one aspect of the present disclosure includes: a receiving section that receives information on association between services and resources; and a transmitting section performs transmission processing by using a resource that is included in the information on association and corresponds to a service to be used.

### Advantageous Effects of Invention

According to one aspect of the present disclosure, when there are TRPs that support different services, communication can be appropriately controlled.

### BRIEF DESCRIPTION OF DRAWINGS

FIG. 1 is a diagram to show examples of the frequency region to which a local NW is allocated;

FIG. 2 is a diagram to show an example of a communication environment in which a licensed NW and local NWs are used;

FIG. 3 is a diagram to show an example in which TRPs of different services exist in the same cell;

FIG. 4 is a diagram to show an example in which SSBs are grouped by service;

FIG. 5 is a diagram to show an example in which random access channel occasions are grouped by service;

FIG. 6 is a diagram to show an example in which CSI resources are grouped by service;

FIG. 7 is a diagram to show an example of a schematic structure of a radio communication system according to one embodiment;

FIG. 8 is a diagram to show an example of a structure of a base station according to one embodiment;

FIG. 9 is a diagram to show an example of a structure of a user terminal according to one embodiment; and

FIG. 10 is a diagram to show an example of a hardware structure of the base station and the user terminal according to one embodiment.

### DESCRIPTION OF EMBODIMENTS

In future radio communication systems (for example, NR, or Rel. 17 or later versions), it is considered that not only telecommunications carriers (for example, a first business operator) licensed for a certain frequency band but also business operators other than the telecommunications carriers operate 5G systems. For example, the business operators (for example, a second business operator) other than the telecommunications carriers may be a company and the like that desire to use the 5G technology as independent radio for industrial purposes. It is also considered to limit communication conditions (for example, area, station location, or the like) for the second business operator and grant a license to the second business operator individually.

The network operated by the first business operator licensed for a certain frequency band (which may be called a license band, for example) may be called a first network, a 5G licensed network, a licensed 5G network, a licensed network, or a telecommunications carrier network.

The network operated by the second business operator may be called a second network, a local 5G network, a 5G local network, a local network, a station-location-limited network, an area-limited network, or a non-telecommunications carrier network. The second network may be more limited in communication conditions than the first network. For example, as compared with the first network, the second network may have a configuration in which installation areas of transmission/reception points (for example, base stations) are limited (for example, only indoor installation is possible) or have a configuration in which transmission power is limited.

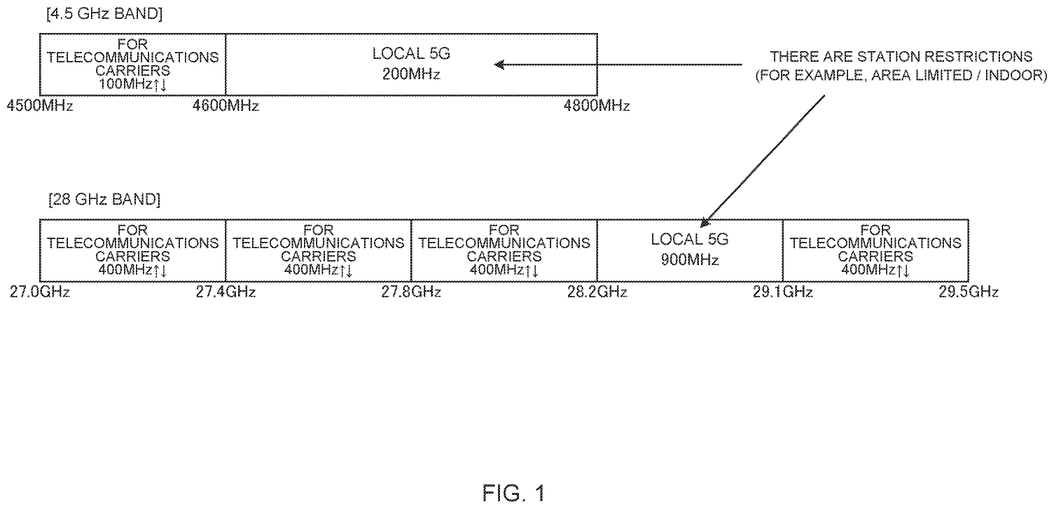

FIG. 1 shows examples of a frequency band to which a local 5G network operated by the second business operator is allocated. FIG. 1 illustrates a case where the local 5G network is operated in a frequency band different from a frequency band allocated to the first business operator (for example, in a frequency band adjacent to the frequency band allocated to the first business operator).

Note that a frequency band in which the local 5G network can be operated is not limited to the above-described case. For example, in the frequency band for which the first business operator is granted a license, the local 5G network with limited communication conditions may be operated. The local 5G network (second network) may be operated by the first business operator.

The UE connects to at least one of the first network (hereinafter, also referred to as a licensed NW) and the second network (hereinafter, also referred to as a local NW).

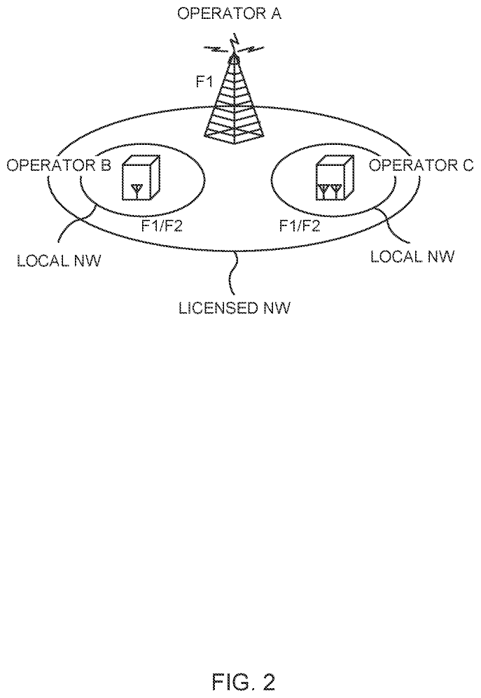

FIG. 2 is a diagram to show an example of a communication environment in which a licensed NW and local NWs are used. FIG. 2 shows a business operator A that operates the licensed NW in a first frequency band (F1) and business operators B and C each of which operates the local NW in at least one of F1 and a second frequency band (F2). For example, the UE may connect to one of the local NWs, and the licensed NW simultaneously so as to perform communication (e.g., carrier aggregation (CA) or dual connectivity (DC)). Alternatively, the UE may be configured such that data are not transmitted or received in one of the NWs (for example, the licensed NW during the connection period with the other NW (for example, the local NW).

The local NW and the licensed NW may be configured in the same frequency region or the same component carrier. Alternatively, the local NW and the licensed NW may be configured in different frequency regions or different component carriers. An unlicensed band may be applied to the local NW.

### Services

Different services may be applied to the local NW and the licensed NW. In the future radio communication systems (for example, NR), assumed services (also referred to as traffic types, service types, communication types, use cases, and the like) are, for example, further advancement of mobile broadband (e.g., enhanced Mobile Broadband (eMBB)), machine type communication that realizes multiple simultaneous connections (e.g., massive Machine Type Communications (mMTC) and Internet of Things (IoT)), and ultra-reliable and low-latency communications (for example, Ultra-Reliable and Low-Latency Communications (URLLC)). For example, in the URLLC, lower latency and higher reliability than those of the case of the eMBB are required.

In the physical layer, each service may be identified on the basis of at least one of the following:
logical channels with different priorities;
Modulation and Coding Scheme (MCS) table (MCS index table);
Channel Quality Indication (CQI) table;
DCI format;
(Radio Network Temporary Identifier (RNTI)) to be used for scrambling (masking) of Cyclic Redundancy Check (CRC) bits included in (added to) the DCI (DCI format);
RRC (Radio Resource Control) parameter;
specific RNTI (for example, RNTI for the URLLC, MCS-C-RNTI, or the like);
search space; and
certain field in the DCI (for example, a field to be newly added or reuse of an existing field).

Specifically, an HARQ-ACK service for the PDSCH may be determined on the basis of at least one of the following:
MCS index table to be used for determining at least one of modulation order, target code rate, and transport block size (TBS), of the PDSCH (for example, whether to use MCS index table 3); and
RNTI to be used for CRC scrambling of the DCI that is used for scheduling the PDSCH (for example, which of C-RNTI and MCS-C-RNTI is used for the CRC scrambling).

The service of SR may be determined on the basis of a higher layer parameter to be used as the SR identifier of SR (SR-ID). The higher layer parameter may indicate whether the service of the SR is the eMBB or the URLLC.

The service of CSI may be determined on the basis of configuration information on CSI reporting (CSIreportSetting), a DCI type or a DCI transmission parameter to be used for a trigger, and the like. The above-described configuration information, DCI type, and the like may indicate whether the service of CSI is the eMBB or the URLLC. The configuration information may be a higher layer parameter.

The service of a PUSCH may be determined on the basis of at least one of the following:
MCS index table to be used for determining at least one of the modulation order, the target code rate, and the TBS, of the PUSCH (for example, whether to use MCS index table 3); and
RNTI to be used for CRC scrambling of DCI that is used for scheduling the PUSCH (for example, which of the C-RNTI and the MCS-C-RNTI is used for the CRS scrambling).

Services may be associated with communication requirements (requirements and requirement conditions such as latency and error rate), data types (such as voice and data), and the like.

The difference between the requirements of the URLLC and the requirements of the eMBB may be that latency of the URLLC is smaller than the latency of the eMBB or may be that the requirements of the URLLC include a reliability requirement.

For example, the requirements for user (U) plane latency in the eMBB may include that the downlink U-plane latency is 4 ms and the uplink U-plane latency is 4 ms. Meanwhile, the requirements for U-plane latency in the URLLC may include that the downlink U-plane latency is 0.5 ms and the uplink U-plane latency is 0.5 ms. The reliability requirements for the URLLC may include a 32-byte error rate of 10−5 at U-plane latency of 1 ms.

As enhanced Ultra Reliable and Low Latency Communications (eURLLC), advancement of reliability of traffic mainly for unicast data is considered. In the following description, when the URLLC and the eURLLC are not distinguished, both are simply referred to as the URLLC.

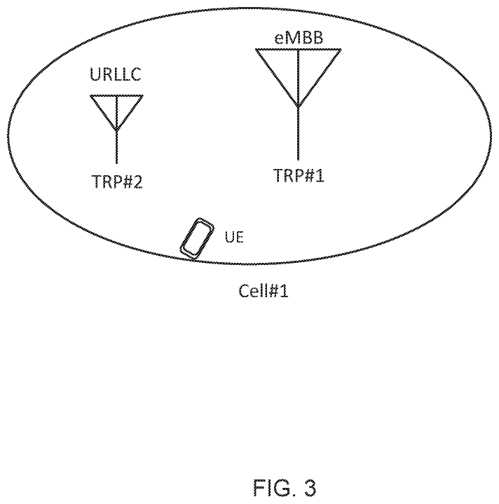

FIG. 3 is a diagram to show an example in which TRPs of different services exist in the same cell. TRP #1 in FIG. 3 denotes the TRP of the licensed NW operated by the first business operator and is assumed to support the eMBB as a service. TRP #2 in FIG. 3 denotes the TRP of the local NW operated by the second business operator and is assumed to support the URLLC as a service. TRP #1 and TRP #2 exist in the same cell (Cell #1).

For example, it is assumed that only a specific UE (for example, a terminal in a factory) is connected to TRP #2. In this case, it is conceivable to use a Closed Access Group (CAG) function that limits connection to only the pre-registered UE. The CAG function may also be referred to as a Closed Subscriber Group (CSG) function. However, when the CAG function is used, though the pre-registered UE (CAG registered UE) can connect to Cell #1, an unregistered mobile terminal apparatus (CAG non-registered UE) cannot connect to Cell #1 even in a case of being located within the service area (coverage) of Cell #1.

Thus, even under the condition where the CAG function has been configured, when the specific UE is a CAG non-registered UE, there is a possibility that this specific UE cannot connect to TRP #2 in Cell #1. When the CAG function is not configured, every UE that connects to Cell #1 may be able to connect to TRP #2.

In addition, the UE may execute CSI measurement and reporting for each TRP (group-based reporting) so as to connect to TRP #2 (configure TCI-state) when the CSI of TRP #2 is better in quality than the CSI of TRP #1. However, when the CSI measurement is used in this manner, an unintended UE (i.e., a UE other than the above-described specific UE) may be connected to TRP #2 due to a measurement error or the like.

In other words, in the case of using existing functions, it is difficult to appropriately control the communication when there are TRPs that support different services. For example, when there are TRPs of different services, it is difficult to connect only the specific UE to the TRP that supports the specific service.

In view of this, the inventors of the present invention came up with the idea of a terminal (UE) including: a receiving section configured to receive information on association between services and resources; and a transmitting section configured to perform transmission processing by using a resource that is included in the information on association and corresponds to a service to be used by the terminal itself. According to one aspect of the present disclosure, when there are TRPs that support different services, communication can be appropriately controlled.

Hereinafter, embodiments of the present disclosure will be described in detail by referring to the accompanying drawings. The radio communication methods of the respective embodiments may be applied individually or may be applied in combination. Note that “A/B” may be interpreted as “at least one of A and B” in the present disclosure.

Although a description will be given of a case where networks of different business operators are exemplified by a licensed NW and a local NW, the classification or type of NW is not limited to the above-described case. Although a plurality of NWs having different business operators will be described in the following, it can also be applied to a plurality of NWs having the same business operator.

In the present disclosure, networks of the same business operator may be interpreted as networks having the same business operator ID. Networks of different business operators may also be interpreted as networks that are different in business operator ID. The networks of different business operators may also be interpreted as networks that are different in at least cell ID (virtual cell ID). The networks of different business operators may also be interpreted as networks that are different in at least one of TRP and service. A network may be interpreted as a cell or a component carrier (CC). A service (such as eMBB and URLLC) may be interpreted as a TRP, a plurality of TRPs, a panel, or a plurality of panels.

In the present disclosure, a panel, an Uplink (UL) transmission entity, a TRP, a spatial relation, a control resource set (CORESET), a PDSCH, a codeword, a base station, a certain antenna port (for example, a demodulation reference signal (DMRS) port), a certain antenna port group (for example, a DMRS port group), a certain group (for example, a code division multiplexing (CDM) group, a certain reference signal group, and a CORESET group), and the like may be interchangeably interpreted.

In the present disclosure, a panel Identifier (ID) and a panel may be interchangeably interpreted. Similarly, a TRP ID and a TRP may be interchangeably interpreted, a CORESET group ID and a CORESET group may be interchangeably interpreted, and the like. An ID and an index may be interchangeably interpreted. A group, grouping, a sequence, a list, and a set in the present disclosure may be interchangeably interpreted.

### Radio Communication Method

### First Embodiment

In the first embodiment, as the information on association between services and resources, a UE receives information indicating the group to which a synchronization signal block belongs. This information may indicate a group (set) including at least one synchronization signal block index, may indicate the association between the services and the groups, or may include an index related to the service corresponding to the group. The UE then receives a synchronization signal block belonging to the group that corresponds to the service supported or to be used by the terminal itself (the UE itself), and transmits a physical random access channel (PRACH) at a random access channel occasion (RACH occasion, PRACH occasion) corresponding to the received synchronization signal block. The synchronization signal block is also referred to as an SS block (Synchronization Signal block (SSB)), an SS/PBCH block, or the like. In the first embodiment, a resource may be a synchronization signal block. In the present disclosure, the synchronization signal block, the synchronization signal block index, and a time resource of the synchronization signal block may be interchangeably interpreted.

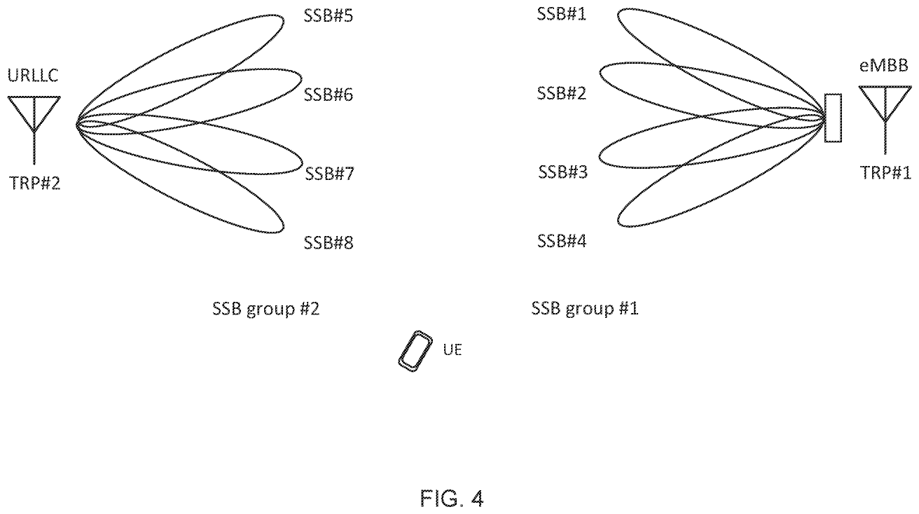

FIG. 4 is a diagram to show an example in which SSBs are grouped by service. It is assumed that TRP #1 in FIG. 3 supports eMBB as a service. It is also assumed that TRP #2 in FIG. 3 supports URLLC as a service. The services supported by TRP #1 and TRP #2 may be services other than the eMBB and the URLLC.

SSBs #1 to #4 to be transmitted by TRP #1 belong to SSB group #1. SSB group #1 is associated with the eMBB (TRP #1). SSBs #5 to #8 to be transmitted by TRP #2 belong to SSB group #2. SSB group #2 is associated with the URLLC (or TRP #2).

A base station (at least one TRP) may transmit information (for example, an identifier) indicating the group (service) to which the SSB to be transmitted belongs, to the UE by using broadcast information. The broadcast information may be a master information block (MIB) or information obtained by enhancing/changing the MIB (which may be referred to as an enhanced MIB (eMIB), for example). The broadcast information may also be a system information block (SIB), a SIB-1, or information obtained by enhancing/changing the SIB (which may be referred to as an enhanced SIB (eSIB), for example). The broadcast information (for example, the MIB) may be carried by a Physical Broadcast Channel (PBCH). The broadcast information (for example, the SIB) may be carried by a Physical Downlink Shared Channel (PDSCH).

The UE may receive any of synchronization signal blocks that belong to the group corresponding to the service supported by the terminal itself (the UE itself). From among the received synchronization blocks, the UE may select the synchronization signal block that belongs to the group corresponding to the service supported by the terminal itself. The UE transmits the PRACH at the RACH occasion corresponding to the received or selected synchronization signal block. The service supported by the UE may be configured as terminal information in the UE in advance. The CE transmits information indicating the service supported by the terminal itself (the UE itself) by higher layer signaling (for example, RRC signaling). The information indicating the service supported by the UE may be a Qos Class Indicator (QCI) or UE capability information. The UE may be configured with the service to be use, by higher layer signaling (for example, RRC layer signaling).

In the case shown in FIG. 4, when supporting the eMBB, the UE receives the synchronization signal block corresponding to any of SSBs #1 to #4 that belong to SSB group #1 corresponding to the eMBB, and transmits the PRACH at the RACH occasion corresponding to the received synchronization signal block. When supporting the URLLC, the UE transmits the PRACH at the RACH occasion corresponding to any of SSBs #5 to #8 that belong to SSB group #2 corresponding to the URLLC. The UE may transmit the PRACH at the RACH occasion corresponding to any of SSBs #1 to #4, to TRP #1. The UP may transmit the PRACH at the RACH occasion corresponding to any of SSBs #5 to #8, to TRP #2.

The base station (for example, the TRP that has received the PRACH) transmits a random access response (RAR) to the UE that has succeeded in receiving the PRACH at the above-described RACH occasion. Afterward, the UE may perform processing such as initial connection to the TRP and determination of a receive beam by a procedure similar to that of Rel. 15.

According to the radio communication method of the first embodiment, the UE can transmit the PRACH to the TRP that supports a specific service, and can perform communication. In other words, when there are TRPs that support different services, communication can be appropriately controlled.

### Second Embodiment

In a second embodiment, as information on association between services and resources, a UE receives information indicating the group to which the random access channel occasion (RACH occasion) belongs. This information may indicate a group (set) including at least one RACH occasion (number), may indicate the association between the services and the groups, or may include an index related to the service corresponding to the group. The UE receives the synchronization signal block corresponding to the RACH occasion that belongs to the group corresponding to the service supported or to be used by the terminal itself (the UE itself), and transmits the physical random access channel (PRACH) at the RACH occasion corresponding to the received synchronization signal block. In the second embodiment, a resource may be a RACH occasion. In the present disclosure, a RACH occasion and a PRACH occasion may be interchangeably interpreted.

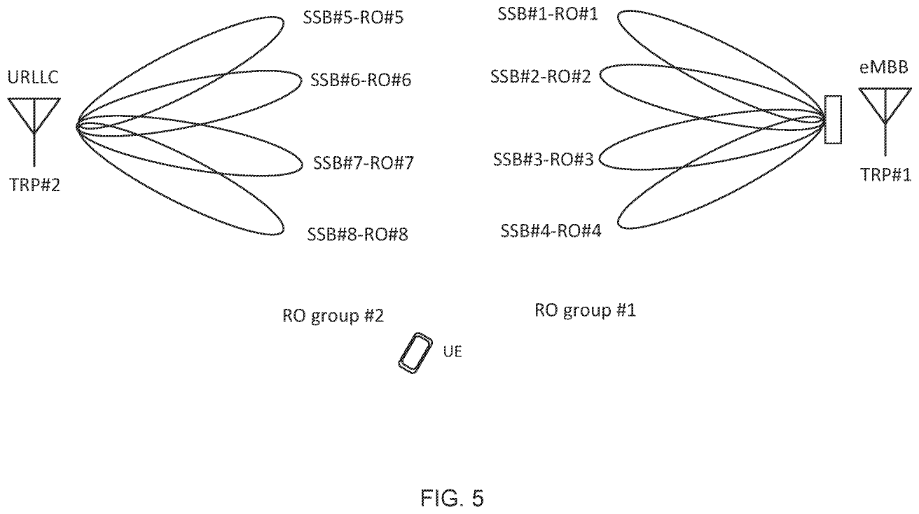

FIG. 5 is a diagram to show an example in which random access channel occasions are grouped by service. It is assumed that eMBB is applied as a service to TRP #1 in FIG. 5. It is also assumed that URLLC is applied as a service to TRP #2 in FIG. 5. The service applied to TRP #1 and TRP #2 may be a service other than the eMBB and the URLLC.

ROs #1 to #4, which are RACH occasions (RO) respectively corresponding to SSBs #1 to #4 to be transmitted by TRP #1, belong to RO group #1. RO group #1 is associated with the eMBB (TRP #1). ROs #5 to #8, which are RACH occasions respectively corresponding to SSBs #5 to #8 to be transmitted by TRP #2, belong to RO group #2. RO group #2 is associated with the URLLC (TRP #2).

The base station (at least one TRP) may transmit information (for example, an identifier) indicating a group (or service) to which the RACH occasion corresponding to the SSB to be transmitted belongs toward the UE by using broadcast information. The broadcast information may be the master information block or information obtained by enhancing/changing the MIB. The broadcast information may be a system information block, SIB-1, or information obtained by enhancing/changing the SIB. The broadcast information (for example, the MIB) may be carried by the PBCH. The broadcast information (for example, the SIB) may be carried by the PDSCH.

The UE may receive synchronization signal blocks corresponding to any of RACH occasions that belong to the group corresponding to the service supported by the terminal itself (the UE itself). From among the received synchronization blocks, the UE may select the synchronization signal block corresponding to the RACH occasion that belongs to the group corresponding to the service supported by the terminal itself. The UE transmits the PRACH at the RACH occasion corresponding to the received or selected synchronization signal block. The service supported by the UE may be configured in the UE as terminal information in advance. The UE transmits information indicating the service supported by the terminal itself (the UE itself) by higher layer signaling (for example, RRC signaling). The information indicating the service supported by the UE may be the QCI or the UE capability information. The UE may be configured with the service to be used, by higher layer signaling (for example, by RRC layer signaling).

In the case shown in FIG. 5, when supporting the eMBB, the UE receives any of the synchronization signal blocks (SSB #1 to #4) corresponding to the RACH occasions (ROs #1 to #4) that belong to RO group #1 corresponding to the eMBB, and transmits the PRACH at the RACH occasion corresponding to the received synchronization signal block. When supporting the URLLC, the UE transmits the PRACH at any of the RACH occasions (ROs #5 to #8) that belong to RO group #2 corresponding to the URLLC. The UE may transmit the PRACH in any of ROs #1 to #4, to TRP #1. The UE may transmit the PRACH in any of ROs #5 to #8, to TRP #2.

The base station (for example, the TRP that has received the PRACH) transmits a random access response (RAR) to the UE that has succeeded in receiving the PRACH in the above-described RACH occasion. Afterward, the UE may perform processing such as the connection to the TRP and the determination of the receive beam by a procedure similar to that of Rel. 15.

According to the radio communication method of the second embodiment, the UE can transmit the PRACH to the TRP that supports the service supported, and can perform the communication. In other words, when there are TRPs that support different services, communication can be appropriately controlled.

### Third Embodiment

In a third embodiment, as information on association between services and resources, a UE receives channel state information (CSI) resource set (CSI resource configuration) information including an identifier related to the services. This information may indicate a CSI resource set including at least one CSI resource ID, may indicate association between the services and CSI resource sets, or may include an index related to the service corresponding to the CSI resource set. The UE then transmits the CSI corresponding to the CSI resource set information that includes the identifier of the service supported or to be used by the terminal itself (the UE itself). In the second embodiment, a resource may be a CSI resource.

In the present disclosure, a CSI resource, a CSI-RS resource, a non-zero power (NZP)-CSI-RS resource, a CSI-interference measurement (IM) resource, a CSI-SSB resource, and an SSB may be interchangeably interpreted. In the present disclosure, a CSI resource set, CSI resource configuration, a CSI resource group, a CSI-RS resource set, an NZP-CSI-RS resource set, a CSI-IM resource set, and a CSI-SSB resource set may be interchangeably interpreted.

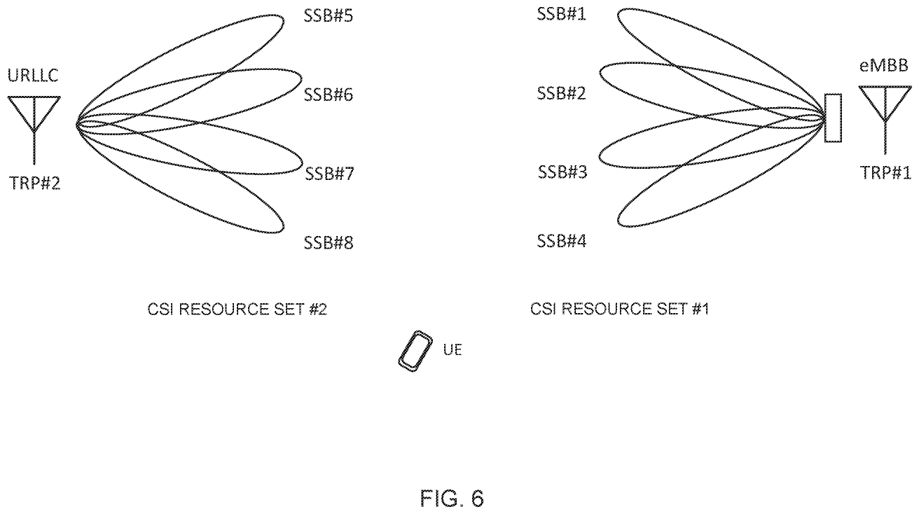

FIG. 6 is a diagram to show in which CSI resources are grouped by service. It is assumed that TRP #1 in FIG. 6 supports eMBB as a service. It is also assumed that TRP #2 in FIG. 6 supports URLLC as a service. The services applied to TRP #1 and TSP #2 may be services other than the eMBB and the URLLC.

The CSI resources corresponding to SSBs #1 to #4 to be transmitted by TRP #1 are included in the CSI resource set #1. The CSI resource set #1 is associated with the eMBB (TRP #1).

The CSI resources corresponding to SSBs #5 to #8 to be transmitted by TRP #2 are included in the CSI resource set #2. The CSI resource set #2 is associated with the URLLC (TRP #2).

CSI-RSs #1 to #8 may be used instead of SSBs #1 to #8. The beams of CSI-RSs #1 to #8 may be the same as the beams of SSBs #1 to #8, respectively.

The TRP includes the identifier for identifying the service applied to the TRP itself in the CSI resource set, and transmits (configures) the resultant to the UE. The identifier may be any of the RNTI of the PUCCH/PUSCH to be used for CSI reporting, the ID related to the series of the DMRS of the PUCCH/PUSCH (for example, the ID indicating at least one of the series and the cyclic shift), the PUCCH resource ID to be reported, the service ID, the TRP ID, and the CSI resource set ID. The UE may measure only the CSI resource set including the identifier of the service supported by the terminal itself (the UE itself). The UE reports (transmits) only the CSI corresponding to the CSI resource set that includes the identifier of the service supported by the terminal itself (the UE itself). The service supported by the UE may be configured as terminal information in the UE in advance. The UE transmits information indicating the services supported by the terminal itself (the UE itself) by higher layer signaling (for example, RRC signaling). The information indicating the services supported by the UE may be QCI or UE capability information. The UE may be configured with the service to be used, by higher layer signaling (for example, RRC layer signaling).

The UE may assign an identifier for identifying the service corresponding to the CSI to be reported (transmitted). The identifier assigned to the report may be any of the RNTI of the PUCCH/PUSCH to be used for the CSI reporting, the ID related to the series of the DMRS of the PUCCH/PUSCH (for example, the ID indicating at least one of the series and the cyclic shift), the PUCCH resource ID to be reported, the CSI report configuration (CSI report config) ID, the service ID, the TRP ID, and the CSI resource set ID. Further, the TRP may transmit (set) the CSI report configuration to the UE for each CSI resource set. The CSI report configuration may include any of information on the RNTI of the PUCCH/PUSCH to be used for the CSI reporting, information on the series of the DMRS of the PUCCH/PUSCH (for example, an ID indicating at least one of the series and the cyclic shift), and information on the PUCCH resource to be reported. The UE reports (transmits) the CSI by using the CSI report configuration that corresponds to the CSI to be reported (transmitted).

Note that, in order to avoid blind decoding of uplink control information (UCI) to be reported, it may be configured such that only the parameters having the same UCI size (having a certain value) are allowed for CSI reporting corresponding to any CSI resource set (group) or the number of bits of each UCI may be changed to the same number by adding certain bits to CSI reporting corresponding to any CSI resource set (group).

The base station (NW) determines the TRP corresponding to the reported CSI as the transmission destination of the signal/channel of the UE. The base station (NW) also determines the beam corresponding to the reported CSI as the beam to be received by the UE.

According to the radio communication method of the third embodiment, the UE can execute the CSI reporting with respect to the TRP to which the supported service is applied, and can perform communication. In other words, when there are TRPs that support different services, communication can be appropriately controlled.

Note that the UE may perform the processing of the third embodiment after completing the processing of the first embodiment or the second embodiment.

### Fourth Embodiment

In a fourth embodiment, a UE transmits information indicating the services supported or to be used by the terminal itself (the UE itself), and receives an execution indication of channel state information (CSI) measurement for the service supported by the terminal itself (for TRP corresponding to the service), as the information on association between services and resources. The execution indication may be at least one configuration information item on the CSI measurement and the CSI reporting notified by RRC signaling or may be a trigger notified by the DCI. The UE executes the CSI measurement for the execution indication (service) and transmits (reports) the measured CSI. The resource in the fourth embodiment may be the CSI.

The UE may perform the initial connection to the TRP by a procedure similar to that of Rel. 15. The UE transmits (reports) the information indicating the services supported by the terminal itself (the UE itself) by higher layer signaling (for example, RRC signaling). The information indicating the service supported by the UE may be QCI or UE capability information.

The UE receives an execution indication of the CSI measurement and the CSI reporting (transmission) for the service supported by the terminal itself (the UE itself) from the base station (NW, at least one TRP). In response to the execution indication of the CSI measurement and the CSI reporting (transmission), the UE executes the CSI measurement for the supported service (for the TRP corresponding to the service) (or measures the reference signal from the TRP corresponding to the service). Subsequently, the UE reports (transmits) the measured CSI to the base station. The base station determines the beam on the basis of the reported CSI. The beam may be at least one of a transmit beam of the base station (TRP corresponding to the service), a receive beam of the base station, and a panel of the base station.

According to the radio communication method of the fourth embodiment, the UE can execute CSI measurement and CSI reporting (transmission) for the supported services. In other words, when there are TRPs to which different services are applied, communication can be appropriately controlled.

According to each embodiment described above, the UE receives the information on association between services and resources. Further, of the information on association, the UE uses the resource corresponding to the service supported by the terminal itself to perform transmission processing. Consequently, when there are TRPs to which different services are applied, communication can be appropriately controlled.

Note that the UE may perform the processing of the fourth embodiment after performing the processing of the first embodiment or the second embodiment.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

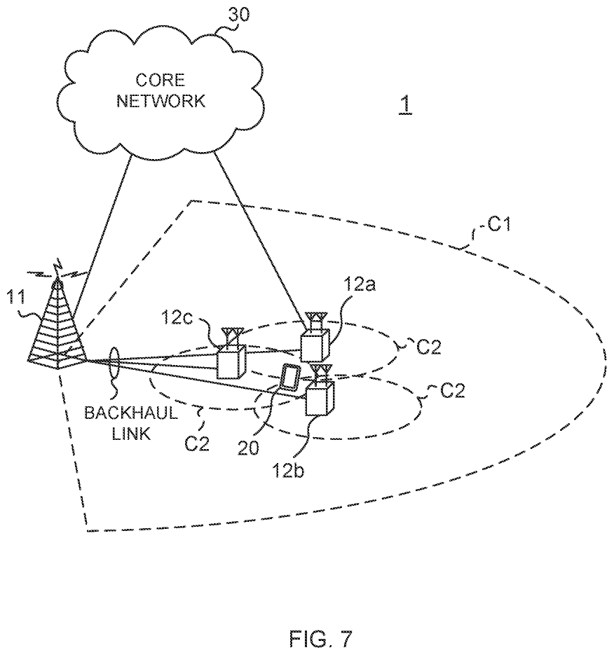

FIG. 7 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LIE, LTE-A, 5G, and so on.

In the radio communication system 1, an orthogonal frequency division multiplexing (OFDM)-based wireless access scheme may be used. For example, at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated. as an uplink reference signal (UL-RS). Note that DMRS may be referred to as a “user terminal specific reference signal (UE-specific Reference Signal).”

### Base Station

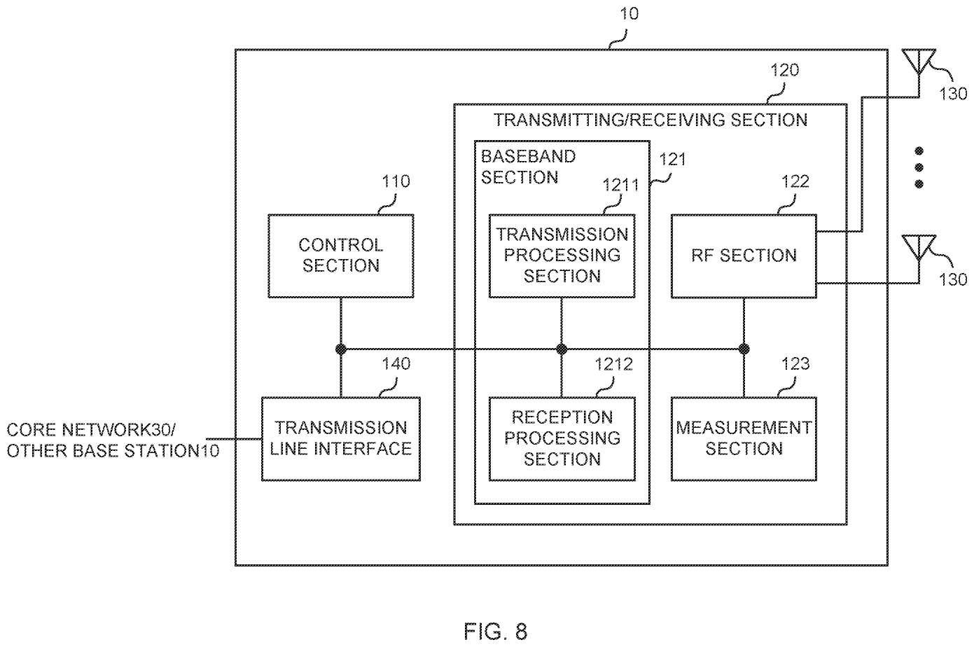

FIG. 8 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing or the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmission/reception section 120 may transmit information on association between services and resources to the UE (user terminal 20). Note that the information on association between services and resources may be information indicating the group to which a synchronization signal block belongs, information indicating the group to which a RACH occasion belongs, CSI resource set information including identifiers related to the services, or an execution indication of CSI measurement for the services supported by the UE. Note that the terms “notification”, “indication”, “configuration”, and “transmission” in the present disclosure may be interpreted interchangeably.

### User Terminal

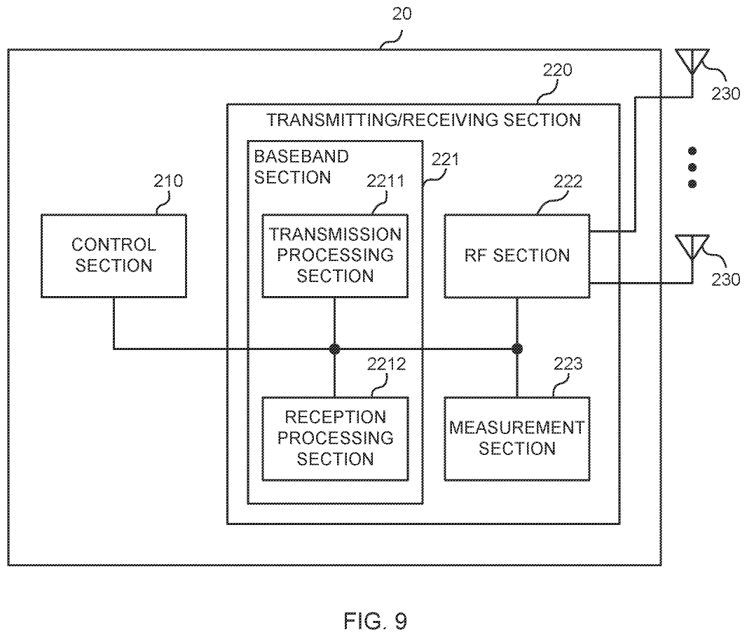

FIG. 9 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that, the user terminal 20 may include other functional blocks that are necessary for radio communication as well. Part or the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RPM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmission/reception section 220 may receive information on association between services and resources. Note that the information on association between services and resources thus received may be information indicating the group to which a synchronization signal block belongs, information indicating the group to which a RACH occasion belongs, CSI resource set information including an identifier related to the service, or an execution indication of CSI measurement for the service supported by the UE.

Of the information on association between services and resources, the transmission/reception section 220 uses the resource corresponding to the service to be used by the terminal itself for performing the transmission processing to the base station 10. The transmission/reception section 220 may transmit a PRACH in the RACH occasion corresponding to the synchronization signal block that belongs to the group corresponding to the service to be used by the terminal itself. The transmission/reception section 220 may transmit the PRACH in the RACH occasion that belongs to the group corresponding to the service to be used by the terminal itself. The transmission/reception section 220 may transmit the CSI corresponding to the CSI resource set that includes the identifier of the service to be used by the terminal itself. The transmission/reception section 220 may transmit information indicating the service supported by the terminal itself and the measured CSI.

The control section 210 may execute the CSI measurement.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

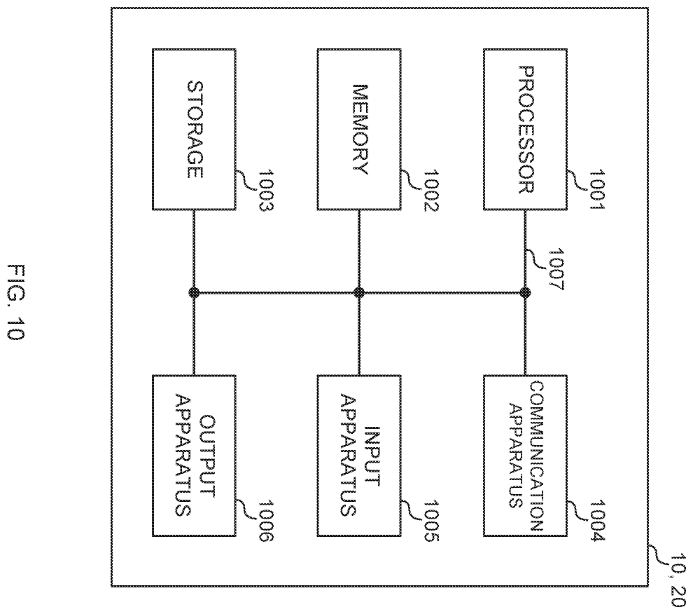

For example, a base station, a user terminal, and so on according to one embodiment of the present disclosure may function as a computer that executes the processes of the radio communication method of the present disclosure. FIG. 10 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or different manners with two or more processors. Note that the processor 1001 may be implemented with one more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Feld Programmable Gate Array (FPGA), and so on, and part or all of the functional blocks may be implemented by the hardware. For example, the processor 1001 may be implemented with at least one of these pieces of hardware.

### Variations

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as aa “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mind-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data. packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 6 to Rel. 12), a “long TTI,” a “normal subframe,” “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (SGWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered. as long as inconsistencies do not arise. For example, although various methods have beer illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives information on association between services and resources; and
a transmitting section performs transmission processing by using a resource that is included in the information on association and corresponds to a service to be used.

2. The terminal according to claim 1, wherein the receiving section receives information indicating a group to which a synchronization signal block belongs, as the information on association, and receives a synchronization signal block that belongs to a group corresponding to the service to be used, and the transmitting section transmits a physical random access channel at a random access channel occasion corresponding to the synchronization signal block thus received.

3. The terminal according to claim 1, wherein the receiving section receives information indicating a group to which a random access channel occasion belongs, as the information on association, and receives a synchronization signal block corresponding to a random access channel occasion that belongs to a group corresponding to the service to be used, and the transmitting section transmits a physical random access channel at a random access channel occasion corresponding to the synchronization signal block.

4. The terminal according to claim 1, wherein the receiving section receives channel state information (CSI) resource set information including identifiers related to the services, as the information on association; and the transmitting section transmits CSI corresponding to a CSI resource set that includes an identifier of the service to be used.

5. The terminal according to claim 1, further comprising:
a control section that executes measurement of channel state information (CSI), wherein
the transmitting section transmits information indicating a service supported by the terminal itself;
the receiving section receives, as the information on association, an execution indication of the measurement of CSI for the service supported by the terminal itself;
the control section executes the measurement of CSI for the execution indication, and
the transmitting section transmits the CSI thus measured.

6. A radio communication method for a terminal, the radio communication method comprising:
receiving information on association between services and resources; and
performing transmission processing by using a resource that is included in the information on association and corresponds to a service to be used.

7. The terminal according to claim 2, wherein the receiving section receives channel state information (CSI) resource set information including identifiers related to the services, as the information on association; and the transmitting section transmits CSI corresponding to a CSI resource set that includes an identifier of the service to be used.

8. The terminal according to claim 3, wherein the receiving section receives channel state information (CSI) resource set information including identifiers related to the services, as the information on association; and the transmitting section transmits CSI corresponding to a CSI resource set that includes an identifier of the service to be used.

9. The terminal according to claim 2, further comprising:
a control section that executes measurement of channel state information (CSI), wherein
the transmitting section transmits information indicating a service supported by the terminal itself;
the receiving section receives, as the information on association, an execution indication of the measurement of CSI for the service supported by the terminal itself;
the control section executes the measurement of CSI for the execution indication, and
the transmitting section transmits the CSI thus measured.

10. The terminal according to claim 3, further comprising:
a control section that executes measurement of channel state information (CSI), wherein
the transmitting section transmits information indicating a service supported by the terminal itself;
the receiving section receives, as the information on association, an execution indication of the measurement of CSI for the service supported by the terminal itself;
the control section executes the measurement of CSI for the execution indication, and
the transmitting section transmits the CSI thus measured.
